(19) United States
(12) Patent Application Publication
(10) Pub. No.: US 2025/0128644 A1
(43) Pub. Date: Apr. 24, 2025

(54) COOLANT DISTRIBUTOR DEVICE FOR A MOTOR VEHICLE, AND MOTOR VEHICLE COMPRISING A COOLANT DISTRIBUTOR DEVICE

(71) Applicant: Volkswagen Aktiengesellschaft, Wolfsburg (DE)

(72) Inventors: Jessica Wolf, Lehre (DE); Kai Hartel, Lehrte (DE); Heino Schiller, Braunschweig (DE); Daniel Blasko, Kissenbrück (DE); Ralf Lüders, Peine (DE)

(21) Appl. No.: 18/688,286

(22) PCT Filed: Aug. 30, 2022
(86) PCT No.: PCT/EP2022/074049

§ 371 Date: Mar. 21, 2024

(30) Foreign Application Priority Data
Aug. 31, 2021 (DE) 102021209519.4

(51) Int. Cl. B60L 58/26; B60K 1/00; B60K 1/04; B60K 11/02; B60L 58/27

(52) U.S. Cl. CPC B60L 58/26; B60K 1/04; B60K 11/02; B60L 58/27; B60K 2001/008; B60K 2001/0438; B60L 2240/545

(57) ABSTRACT

Technologies and techniques for reducing the construction space necessary for a heating element of a motor vehicle and to improve the cooling of such a heating element. A coolant distributor device may be provided for a motor vehicle, such as a hybrid electric motor vehicle or a battery-electric vehicle, including a basic body with coolant lines, arranged running in the basic body, wherein a heating element is arranged in and/or on the basic body.

### RELATED APPLICATIONS

The present application claims priority to International Patent Application No. PCT/EP2022/074049 to Wolf et al., filed Aug. 30, 2022, titled “Coolant Distributor Device For A Motor Vehicle, And Motor Vehicle Comprising A Coolant Distributor Device,” which claims priority to German Pat. App. No. DE 10 2021 209 519.4, filed Aug. 31, 2021, to Wolf et al., the contents of each being incorporated by reference in their entirety herein.

### TECHNICAL FIELD

The present disclosure relates to a coolant distributor device for a motor vehicle, in particular for a hybrid electric motor vehicle or a battery-electric vehicle, comprising a base body with coolant lines arranged so as to run in the base body.

The present disclosure furthermore relates to a motor vehicle comprising a coolant distributor device.

### BACKGROUND

Heating elements, in particular high-voltage heating elements, are used in the prior art for controlling the temperature of, and in particular for heating, the battery of a hybrid electric motor vehicle or battery-electric vehicle, so as to maintain the battery in an optimal temperature window. In addition, it is possible to use such heating elements for heating a passenger compartment of the motor vehicle.

It is known in the prior art to connect heating elements to a coolant circuit of the motor vehicle via coolant lines. Heating elements connected in this way require a lot of installation space. Additionally, the heating capacity requirements and the requirements for transferring thermal energy to the coolant are steadily increasing. The achievable heating capacity is often limited due to the control electronics of the heating element overheating. In the prior art, it is attempted to meet the risen heating capacity requirements by enlarging the heating element. Larger heating elements, however, require more installation space and cause higher costs. In addition, the heating elements have to be attached in the motor vehicle using a separate holder, which entails additional design complexity.

A Positive Temperature Coefficient (PCT) liquid heating element for a motor vehicle is known from CN 110053453 A, which comprises a control unit, a high-voltage circuit board, an Insulated Gate Bipolar Transistor (IGBT) module, a high-voltage adapter, and a water chamber.

CN 108263165 A discloses an electrical heating system comprising a heating element. A Printed Circuit Board Assembly (PCBA) is arranged on the upper side of the heating element. Sealing material is arranged between the PCBA and a heat sink.

EP 1 366 937 A2 discloses an electrical heating device for heating air, in particular for a motor vehicle. The electrical heating device comprises electrical heating units, which are connected in a thermally conducting manner to units for receiving a fluid medium, in particular water, and/or heat exchange units, in particular corrugated fins. The unit for receiving the fluid medium is additionally in thermally conducting contact with the heat exchanger unit. Power semiconductors, which are controlled by integrated or external closed-loop and/or open-loop control units, are used as electrical heating units.

### SUMMARY

Aspects of the present disclosure are directed to reducing the installation space required for a heating element of a motor vehicle, and to improve the cooling of such a heating element.

In some examples, a coolant distributor device for a motor vehicle, in particular for a hybrid electric motor vehicle or a battery-electric vehicle, comprising a base body with coolant lines arranged so as to run in the base body, is disclosed, it being furthermore provided that a heating element is arranged in and/or at the base body.

In some examples, a motor vehicle, in particular a hybrid electric motor vehicle or a battery-electric vehicle, is disclosed, comprising an above-described coolant distributor device.

### DESCRIPTION OF THE DRAWINGS

Aspects of the present disclosure are described in greater detail hereafter based on the accompanying figures. In the drawings:

FIG. 1 shows a coolant circuit comprising a heating element known from the prior art;

FIG. 2a shows a coolant distributor device comprising a heating element in a view from above, according to some aspects of the present disclosure;

FIG. 2b shows a coolant distributor device comprising a heating element in a cross-sectional view, according to some aspects of the present disclosure; and

FIG. 3 shows a motor vehicle comprising a coolant distributor device, according to some aspects of the present disclosure.

### DETAILED DESCRIPTION

So as to reduce the design complexity of coolant circuits for motor vehicles, coolant distributor devices are known, which are used to substitute coolant hoses. Coolant lines are arranged in the coolant distributor device for this purpose, whereby the number of required coolant hoses is reduced.

According to the present disclosure, it is provided that the heating element is arranged in and/or at the base body. By arranging the heating element in and/or at the base body, an additional holder for attaching the heating element in the motor vehicle can be dispensed with. As a result, the design complexity is reduced. Moreover, additional coolant hoses or coolant lines for connecting the heating element to the coolant distributor device can be dispensed with, whereby thermal losses are reduced. In addition, the efficiency of the heating element can be increased by arranging the heating element at and/or in the base body.

The coolant lines are preferably arranged so as to run integrated in the base body. This can, in particular, mean that the base body is configured as a substantially monolithic or solid component, wherein the coolant lines are created in the base body by boreholes or are already created during the production of the base body of the coolant distributor device. The material of the base body itself thus forms the walls of the coolant lines.

The heating element is preferably provided to heat a coolant that is conducted, or can be conducted, through the coolant lines, so that a battery, and in particular a battery for electrically driving a hybrid electric motor vehicle or a battery-electric vehicle, can be controlled in terms of the temperature thereof, or heated, by way of the heated coolant. Furthermore, it is also possible to heat a passenger compartment by means of the coolant heated by the heating element.

It is also possible for several heating elements to be provided.

Preferably, it is provided that the heating element is integrated into the base body, more preferably the base body forming a housing of the heating element.

In other words, the heating element is at least partly, and preferably completely, arranged in the interior of the base body. For this purpose, an opening can be provided in the base body during the production of the base body of the coolant distributor device, through which the heating element is inserted into the base body. The opening can subsequently be closed by an appropriate component.

By integrating the heating element into the base body, the required installation space is reduced, and the complexity of the coolant circuit for a motor vehicle is decreased. Moreover, a separate housing for the heating element can be dispensed with. Rather, the base body itself forms the housing of the heating element. Since the coolant lines of the coolant distributor device are arranged so as to run in the base body, additionally the heat transfer from the heating element to the coolant conducted or conductable in the coolant lines can be improved.

More preferably, it is provided that the base body has a substantially plate-shaped design, and/or that the coolant distributor device is a coolant distributor plate.

As a result of the plate-shaped configuration of the base body or as a result of the configuration of the coolant distributor device as a coolant distributor plate, this design is particularly space-saving.

Preferably, it is furthermore provided that the heating element is a high-voltage heating element, and more preferably a PTC heating element.

Further advantageously, it may be provided that the heating element and the coolant lines are arranged in the base body in such a way that a coolant, in particular water, can be supplied to the heating element from at least one of the coolant lines, and/or that a coolant, in particular water, can be supplied from the heating element to at least one of the coolant lines.

In other words, the heating element is arranged in and/or at the base body in such a way that a coolant, for example water, can be supplied thereto directly from the coolant lines of the base body. This coolant, in particular the water, is then heated by the heating element and given off to a further coolant line arranged in the base body. As a result of this direct fluidic connection between the heating element and the coolant lines, additional coolant lines or coolant hoses can be dispensed with. In addition, thermal losses can be avoided by dispensing with additional coolant lines or coolant hoses, whereby the efficiency of the heating element is increased.

Preferably, it is provided for this purpose that connecting devices of the coolant lines are arranged in the base body, wherein the heating element is connected to the connecting devices.

In other words, when arranged in or integrated into the base body of the coolant distributor device, the heating element is connected to the connecting devices of the coolant lines provided in the base body. The coolant, in particular water, that is conducted or can be conducted by the coolant lines can thus be supplied directly to the cooling element, which heats the coolant, via a first coolant line and the connecting device thereof. The heated coolant can then be supplied to a second coolant line via a further connecting device. The heated coolant is then available for heating further components of the motor vehicle, for example the battery or the passenger compartment.

The heated coolant, and in particular the heated water, can moreover also be used for controlling the temperature of or heating the electric drive, the vehicle radiator and further electronics of the motor vehicle.

In particular, it is preferably provided that the heating element has a coolant inlet and a coolant outlet, wherein the coolant inlet and the coolant outlet are each connected to a connecting device.

Further advantageously, it may be provided that the base body comprises a receptacle, wherein an electronics unit, in particular a circuit board, further in particular an electronic control device, is arranged, in particular inserted, in the receptacle.

The electronics unit can be any suitable electronics unit of the motor vehicle which has to be cooled. The receptacle can also be configured as a pocket into which the electronics unit has been or is inserted. In this way, an insertion solution for an electronics unit into the base body of the coolant distributor device is provided.

The electronics unit, and in particular the circuit board, is preferably an electronic control device for the heating element.

Advantageously, it is provided that the coolant lines are arranged in the base body in such a way that the electronics unit, and in particular the circuit board, arranged in the receptacle can be cooled by way of a coolant, in particular, that is conducted or can be conducted in the coolant lines.

In other words, the coolant lines run in the base body in such a way that heat given off by the electronics unit can be absorbed by a coolant, in particular water, conducted in the coolant lines. This can be achieved in that at least one of the coolant lines is arranged so as to run in the immediate vicinity of the receptacle, and thus in the immediate vicinity of the electronics unit arranged in the receptacle in the base body. In addition, however, it may also be provided that the coolant, with an appropriate configuration of the electronics unit, in particular appropriate sealing of the electronics unit with respect to liquids, can flow from the coolant lines directly into the receptacle, where it flows around and cools the circuit board or the electronics unit.

It is furthermore preferably provided that the base body comprises coolant inlet connections and coolant outlet connections for connecting a cooler for a battery and/or for connecting a heat exchanger, in particular a heat exchanger for a passenger compartment of a motor vehicle.

The coolant inlet connections and coolant outlet connections are in particular arranged at an outer side of the base body.

Preferably, it is provided that at least one pump, in particular a circulating coolant pump, further in particular a circulating water pump, is arranged in the base body, in particular in the coolant lines.

Furthermore, it may be provided that the base body comprises electrical terminals, in particular a high-voltage terminal and/or a low-voltage terminal.

The electrical terminals, in particular the high-voltage terminal and/or the low-voltage terminal, are preferably configured to supply electrical energy to the electronics unit. Electrical energy can, in particular, be supplied to the heating element via the electrical terminals when the electronics unit is a circuit board or an electronic control device for the heating element.

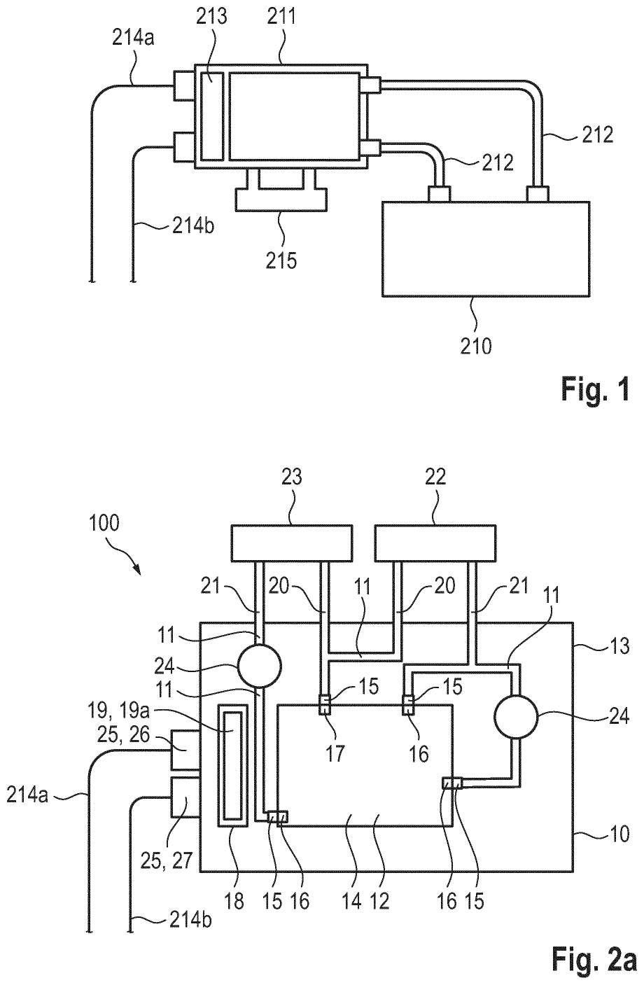

FIG. 1 shows a coolant circuit 210 known from the prior art, comprising a heating element 211 for heating a coolant, in particular water. The heating element 211 is connected to the coolant circuit 210 via coolant hoses 212. The heating element 211 comprises a circuit board 213, which is supplied with energy via a high-voltage line 214a and a low-voltage line 214b. The heating element 211 is attached by means of a holder 215 within a motor vehicle.

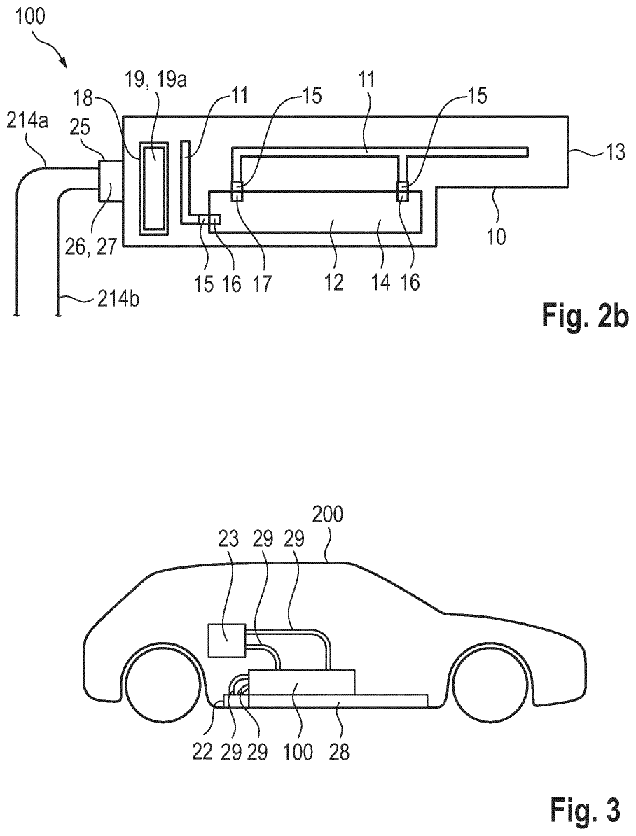

FIG. 2a shows a coolant distributor device 100 in a view from above, and FIG. 2b shows the coolant distributor device 100 in a side view according to some aspects of the present disclosure. The coolant distributor device 100 is provided for a motor vehicle, which is not shown in greater detail, in particular for a hybrid electric motor vehicle or battery-electric vehicle, and comprises a base body 10. Coolant lines 11 may be arranged so as to run in the base body 10. Furthermore, a heating element 12 is integrated into the base body 10.

As is apparent in particular from the side view of FIG. 2b, the base body 10 has a substantially plate-shaped design in the form of a coolant distributor plate 13. The heating element 12 is configured as a high-voltage heating element 14 and arranged in the base body 10 in such a way that a coolant, in particular, can be supplied to the heating element 12 from at least one of the coolant lines 11. The coolant is heated by the heating element 12 and supplied to one of the coolant lines 11 again.

For this purpose, connecting devices 15 of the coolant lines 11 are arranged in the base body 10, to which, in turn, coolant inlets 16 and coolant outlets 17 of the heating element 12 are connected. Furthermore, a receptacle 18 is provided in the base body 10, in which an electronic unit 19 is arranged, in the present case an electronic control device 19a of the heating element 12 which is designed as a circuit board. The receptacle 18 and the electronics unit 19 arranged therein are arranged in the immediate vicinity of one of the coolant lines 11 in the base body 10 so that the electronics unit 19 can likewise be cooled. The base body 10 of the coolant distributor device 100 additionally comprises coolant outlet connections 20 and coolant inlet connections 21, via which a cooler 22 for a battery of the motor vehicle and a heat exchanger 23 for heating a passenger compartment can be connected.

Furthermore, circulating coolant pumps 24 are arranged in the coolant distributor device 100 in suitable locations in the coolant lines 11. Moreover, electrical terminals 25 are provided at the base body 10, in particular a low-voltage terminal 26 and a high-voltage terminal 27, by way of which the electronics unit 19 and the heating element 12 can be supplied with electrical energy.

FIG. 3 schematically shows a motor vehicle 200 comprising a coolant distributor device 100 according to FIGS. 2a and 2b. The motor vehicle comprises a battery 28 comprising a cooler 22 and a heat exchanger 23, which are connected to the coolant distributor device 100 via corresponding coolant hoses 29.

### LIST OF REFERENCE NUMERALS

100 coolant distributor device
10 base body
11 coolant line
12 heating element
13 coolant distributor plate
14 high-voltage heating element
15 connecting device
16 coolant inlet
17 coolant outlet
18 receptacle
19 electronics unit
19a electronic control device
20 coolant outlet connection
21 coolant inlet connection
22 cooler
23 heat exchanger
24 circulating coolant pump
25 electrical terminal
26 low-voltage terminal
27 high-voltage terminal
28 battery
29 coolant hose
200 motor vehicle
210 coolant circuit
211 heating element
212 coolant hose
213 circuit board
214a high-voltage line
214b low-voltage line
215 holder

1-10. (canceled).

11. A coolant distributor device for a motor vehicle, comprising:
a base body including coolant lines arranged to run in the base body; and
a heating element arranged in and/or at the base body.

12. The coolant distributor device of claim 11,
wherein the heating element is integrated into the base body, the base body forming a housing of the heating element, and/or
wherein the base body has a substantially plate-shaped design, and/or
wherein the coolant distributor device is a coolant distributor plate, and/or
wherein the heating element is a high-voltage heating element.

13. The coolant distributor device of claim 11, wherein the heating element comprises a Positive Temperature Coefficient (PCT) heating element.

14. The coolant distributor device of claim 11, wherein the heating element and the coolant lines are arranged in the base body such that a coolant can be supplied to the heating element from at least one of the coolant lines, and/or wherein a coolant can be supplied from the heating element to at least one of the coolant lines.

15. The coolant distributor device of claim 14, further comprising connecting devices of the coolant lines arranged in the base body, wherein the heating element is connected to the connecting devices, the heating element comprising a coolant inlet and a coolant outlet, each connected to a connecting device.

16. The coolant distributor device of claim 11, wherein the base body comprises a receptacle, and an electronics unit is arranged in the receptacle, wherein the electronics unit is a circuit board or an electronic control device for the heating element.

17. The coolant distributor device of claim 16, wherein the coolant lines are arranged in the base body such that the electronics unit arranged in the receptacle can be cooled by way of a coolant that is conducted or can be conducted in the coolant lines.

18. The coolant distributor device of claim 11, wherein the base body comprises coolant inlet connections and coolant outlet connections for connecting a cooler for a battery and/or for connecting a heat exchanger for a passenger compartment of a motor vehicle.

19. The coolant distributor device of claim 11, wherein at least one pump is arranged in the base body, and/or wherein the base body comprises electrical terminals configured to supply electrical energy to the electronics unit and/or the heating element.

20. A motor vehicle, comprising one of a hybrid electric motor vehicle or a battery-electric vehicle, comprising a coolant distributor device, the coolant distributor device comprising:
a base body including coolant lines arranged to run in the base body; and
a heating element arranged in and/or at the base body.

21. The motor vehicle of claim 20,
wherein the heating element is integrated into the base body, the base body forming a housing of the heating element, and/or
wherein the base body has a substantially plate-shaped design, and/or
wherein the coolant distributor device is a coolant distributor plate, and/or
wherein the heating element is a high-voltage heating element.

22. The motor vehicle of claim 21, wherein the heating element comprises a Positive Temperature Coefficient (PTC) heating element.

23. The motor vehicle of claim 20, wherein the heating element and the coolant lines are arranged in the base body such that a coolant can be supplied to the heating element from at least one of the coolant lines, and/or wherein a coolant can be supplied from the heating element to at least one of the coolant lines.

24. The motor vehicle of claim 23, further comprising connecting devices of the coolant lines arranged in the base body, wherein the heating element is connected to the connecting devices, the heating element comprising a coolant inlet and a coolant outlet, each connected to a connecting device.

25. The motor vehicle of claim 20, wherein the base body comprises a receptacle, and an electronics unit is arranged in the receptacle, wherein the electronics unit is a circuit board or an electronic control device for the heating element.

26. The motor vehicle of claim 25, wherein the coolant lines are arranged in the base body such that the electronics unit arranged in the receptacle can be cooled by way of a coolant that is conducted or can be conducted in the coolant lines.

27. The motor vehicle of claim 20, wherein the base body comprises coolant inlet connections and coolant outlet connections for connecting a cooler for a battery and/or for connecting a heat exchanger for a passenger compartment of a motor vehicle.

28. The motor vehicle of claim 20, wherein at least one pump is arranged in the base body, and/or wherein the base body comprises electrical terminals configured to supply electrical energy to the electronics unit and/or the heating element.

29. A coolant distributor device for a motor vehicle, comprising:
a base body including coolant lines arranged to run in the base body; and
a heating element arranged in and/or at the base body,
wherein the heating element is integrated into the base body, the base body forming a housing of the heating element, and/or
wherein the base body has a substantially plate-shaped design, and/or
wherein the coolant distributor device is a coolant distributor plate, and/or
wherein the heating element is a high-voltage heating element.

30. The coolant distributor device of claim 29, wherein the heating element comprises a Positive Temperature Coefficient (PCT) heating element.
